(19) United States
(12) Patent Application Publication
(10) Pub. No.: US 2017/0074485 A1
(43) Pub. Date: Mar. 16, 2017

(54) Local Quantum Dot Optics

(71) Applicant: NANOSYS, Inc., Milpitas, CA (US)

(72) Inventors: Ernest LEE, Milpitas, CA (US); Rob WILSON, Milpitas, CA (US); Jason HARTLOVE, Milpitas, CA (US); David E. STRAIT, Milpitas, CA (US)

(21) Appl. No.: 15/265,526

(22) Filed: Sep. 14, 2016

Related U.S. Application Data
(60) Provisional application No. 62/218,291, filed on Sep. 14, 2015.

(51) Int. Cl. F21V 9/16; F21V 13/08; F21V 15/01

(52) U.S. Cl. CPC F21V 9/16; F21V 15/01; F21V 13/08; Y10S 977/774; B82Y 20/00

(57) ABSTRACT

Embodiments of a local optic using quantum dots are described. A local optic includes an optical source on a substrate, a housing, and a film that includes quantum dots. The housing is designed to fit around the optical source and has a cross-sectional area along a plane parallel to a surface of the substrate. The film is designed to sit on top of the housing and has a substantially similar cross-sectional area to the cross-sectional area of the housing.

### CROSS REFERENCE TO RELATED APPLICATIONS

This application claims the benefit of U.S. provisional application No. 62/218,291 filed Sep. 14, 2015, the disclosure of which is incorporated by references herein in its entirety.

### FIELD

The present application relates to quantum dot emission technology, and to localized optics involving quantum dots.

### BACKGROUND

Semiconductor nanocrystallites (quantum dots) whose radii are smaller than the bulk exciton Bohr radius constitute a class of materials intermediate between molecular and bulk forms of matter. Quantum confinement of both the electron and hole in all three dimensions leads to an increase in the effective band gap of the material with decreasing crystallite size. Consequently, both the optical absorption and emission of quantum dots shift to the blue (higher energies) as the size of the dots gets smaller.

Incorporating quantum dots in display devices, such as LCDs, has been shown to produce highly vibrant colors while reducing the overall power consumption. The quantum dots are typically dispersed within a film that stretches along the area of the display.

### SUMMARY

Embodiments of the present application relate to localizing the use of quantum dot films over LEDs. The embodiments of the present application provide advantages over the traditional technique of providing a film that covers the entire area of a display screen.

According to an embodiment, a local optic includes an optical source on a substrate, a housing, and a film that includes quantum dots. The housing is designed to fit around the optical source and has a cross-sectional area along a plane parallel to a surface of the substrate. The film is designed to sit on top of the housing and has a substantially similar cross-sectional area to the cross-sectional area of the housing.

According to another embodiment, a local optic includes an optical source on a substrate, an enclosure coupled to a surface of the substrate, and a film that includes quantum dots. The enclosure surrounds the optical source above the surface of the substrate. The film is located along an inner surface of the enclosure.

According to another embodiment, a local optic includes an optical source on a substrate, and an enclosure coupled to a surface of the substrate. The enclosure surrounds the optical source above the surface of the substrate and includes quantum dots dispersed within the material of the enclosure. Each quantum dot dispersed within the material of the enclosure is encased within a glass bead.

### BRIEF DESCRIPTION OF THE DRAWINGS/FIGURES

The accompanying drawings, which are incorporated herein and form part of the specification, illustrate the present embodiments and, together with the description, further serve to explain the principles of the present embodiments and to enable a person skilled in the relevant art(s) to make and use the present embodiments.

FIG. 1 illustrates the structure of a quantum dot (QD), according to an embodiment.

FIG. 2 illustrates a quantum dot enhancement film, according to an embodiment.

FIGS. 3A-3C illustrate views of a QD film holder over an LED, according to an embodiment.

FIG. 4 illustrates an enclosure around an LED, according to an embodiment.

FIG. 5 illustrates another enclosure around an LED, according to an embodiment.

FIGS. 6A and 6B illustrate reflective elements on an enclosure, according to some embodiments.

The features and advantages of the present embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

Although specific configurations and arrangements may be discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications beyond those specifically mentioned herein.

It is noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

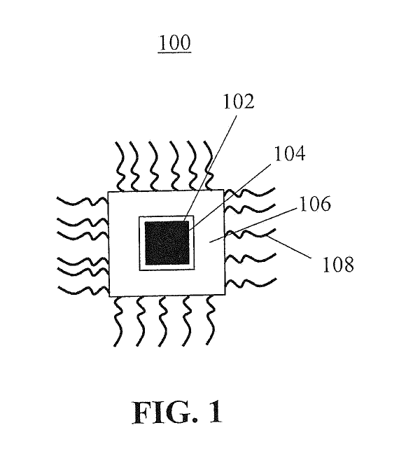

Before describing the details of the embodiments herein, a brief description of quantum dots and the film that the quantum dots are commonly dispersed in will be discussed. Quantum dots may be used in a variety of applications that benefit from having sharp, stable, and controllable emissions in the visible and infrared spectrum. FIG. 1 illustrates an example of the core-shell structure of a quantum dot 100, according to an embodiment. Quantum dot 100 includes a core material 102, an optional buffer layer 104, a shell material 106, and a plurality of ligands 108.

Core material 102 includes a semiconducting material that emits light upon absorption of higher energies. Examples of core material 102 include indium phosphide (InP), cadmium selenide (CdSe), zine sulfide (ZnS), lead sulfide (PbS), indium arsenide (InAs), indium gallium phosphide, (InGaP), and cadmium telluride (CdTe). Any other III-V, tertiary, or quaternary semiconductor structures that exhibit a direct band gap may be used as well. Of these materials, InP and CdSe are most often used, but InP is more desirable to implement over CdSe due to the toxicity of CdSe dust. CdSe may exhibit emissions having a full-width-half-max (FWHM) range of around 30 nm while InP may exhibit emissions having a FWHM range of around 40 nm.

Buffer layer 104 may surround core material 102. Buffer layer 104 may be zinc selenide sulfide (ZnSeS) and is typically very thin (e.g., on the order of 1 monolayer). Buffer layer 104 may be utilized to help increase the bandgap of core material 102 and improve the quantum efficiency.

Shell material 106 may be on the order of two monolayers thick and is typically, though not required, also a semiconducting material. The shells provide protection to core material 102. A commonly used shell material is zinc sulfide (ZnS), although other materials may be used as well. Shell material 106 may be formed via a colloidal process similar to that used to form core material 102.

Ligands 108 may be adsorbed or bound to an outer surface of shell material 106. Ligands 108 may be included to help separate (e.g., disperse) the quantum dots from one another. If the quantum dots are allowed to aggregate as they are being formed, the quantum efficiency drops and quenching of the optical emission occurs. Ligands 108 may also be used to impart certain properties to quantum dot 102, such as hydrophobicity, or to provide reaction sites for other compounds to bind. A wide variety of ligands 108 exist that may be used with quantum dot 102. In an embodiment, ligands 108 from the aliphatic amine or aliphatic acid families are used. Further details on the fabrication of the quantum dots may be found in U.S. application Ser. No. 13/803,596, filed Mar. 14, 2013, the disclose of which is incorporated herein by reference.

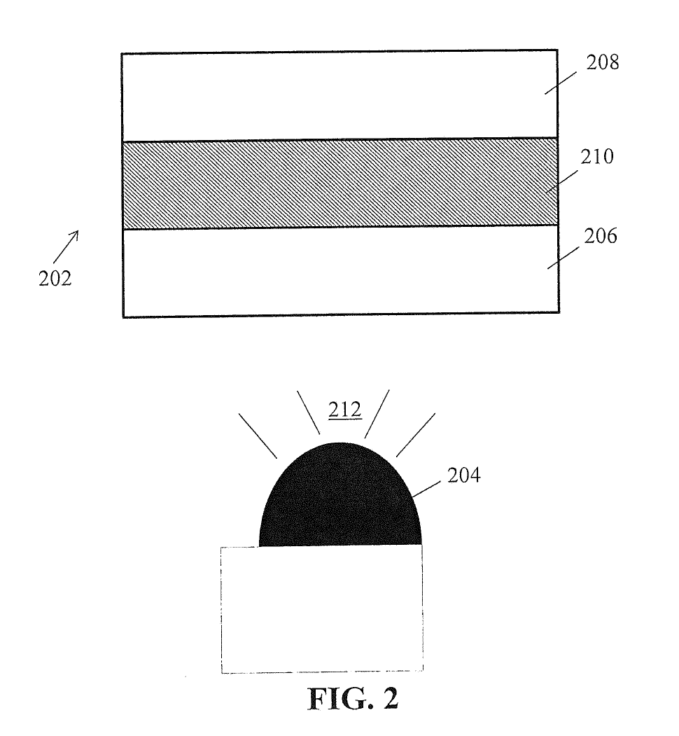

FIG. 2 illustrates an example of a quantum dot enhancement film (QDEF). Quantum dot enhancement film 202 includes a bottom layer 206, a top layer 208, and a quantum dot layer 210 sandwiched between. An optical source 204 provides light 212 from one side of the QDEF 202. Optical source 204 may be a variety of sources and may includes more than one light source. For example, optical source 204 may be one or more laser diodes or one or more light emitting diodes (LEDs). In one embodiment, optical source 204 includes one or more blue LEDs.

Bottom layer 206 and top layer 208 may be a variety of materials that are substantially transparent to the wavelengths being emitted by optical source 204 and the quantum dots trapped within quantum dot layer 210. For example, bottom layer 206 and top layer 208 may be glass or polyethylene terephthalate (PET). Bottom layer 206 and top layer 208 may also by polyester coated with aluminum oxide. Other polymers may be used as well that exhibit low oxygen permeability and low absorption for the wavelengths being emitted by the quantum dots trapped within quantum dot layer 210. It is not necessary that bottom layer 206 and top layer 208 be comprised of the same material.

Quantum dot layer 210 includes a plurality of quantum dots within an adhesive material. According to an embodiment, quantum dot layer 210 has a thickness between about 50 and 150 micrometers (μm) and is used as a light down conversion layer. Quantum dot layer 210 may have a thickness around 100 μm. The adhesive material binds to both bottom layer 206 and top layer 208, holding the sandwich-like structure together.

In an embodiment, the plurality of quantum dots includes sizes that emit in at least one of the green and red visible wavelength spectrums. The quantum dots are protected in quantum dot layer 210 from environmental effects and kept separated from one another to avoid quenching. The quantum dots may be spatially separated by enough distance such that quenching processes like excited state reactions, energy transfer, complex-formation and collisional quenching do not occur.

In one example, quantum dots are mixed within an amino silicone liquid and are emulsified into an epoxy resin that is coated to form quantum dot layer 210. Other example materials for use in quantum dot layer 210 include acrylates, epoxies, acrylated epoxies, ethylene-vinyl acetate, thiol-enes, polyurethane, polyethers, polyols, and polyesters. Further details regarding the fabrication and operation of quantum dot enhancement films may be found in U.S. application Ser. No. 13/287,616, filed on Nov. 2, 2011, the disclosure of which is incorporated herein by reference.

Embodiments herein relate to using quantum dot films and quantum dots dispersed in other materials. The localization of the quantum dot films may greatly reduce fabrication costs.

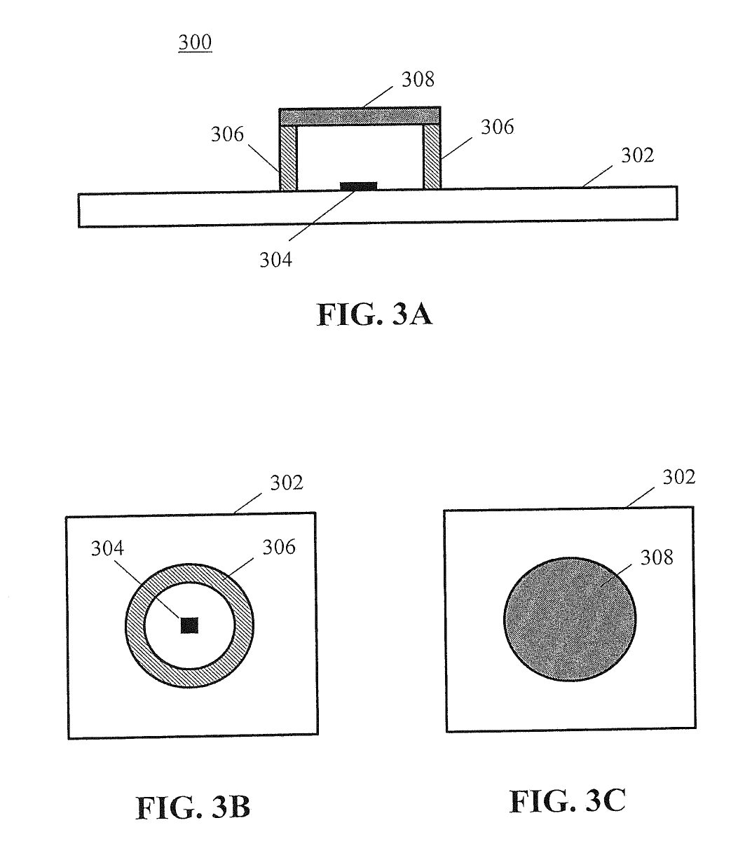

FIG. 3A illustrates a side view of a local optic 300, according to an embodiment. A substrate 302 includes an optical source 304 either mounted to substrate 302, or integrated within substrate 302. For example, optical source 304 may be a surface mount component while substrate 302 is a printed circuit board. In another example, substrate 302 is a semiconductor substrate and optical source 304 is a doped component of the semiconductor substrate. Substrate 302 may also be comprised of plastic or glass. Optical source 304 may be an LED or a laser diode. Optical source 304 may be designed to emit blue wavelengths (e.g., around 450 nm).

A housing 306 is disposed around optical source 304. Housing 306 may be opaque to the wavelengths generated by optical source 304. Housing 306 is attached to a top surface of substrate 302 and can have any cross-sectional shape along a plane parallel to the top surface of substrate 302. For example, housing 306 may have a circular, oval, square, or rectangular cross section. The exact size of housing 306 varies based on the application. When a high density of optical sources are used, each housing around a corresponding optical source may be made smaller to fit each of the housings on the same substrate.

The top portion of housing above optical source 304 is kept open. A quantum dot film 308 may be placed on a top surface of housing 306 as illustrated in FIG. 3A. In this way, light generated from optical source 304 will shine through quantum dot film 308 and excite the various quantum dots dispersed within quantum dot film 308. Quantum dot film 308 may be similar in structure to QDEF 202 illustrated in FIG. 2. According to an embodiment, quantum dot film 308 has a similar cross-sectional area to that of housing 306 along a plane parallel to the surface of substrate 302. For example, if housing 306 has a circular cross sectional area with a diameter of 0.5 inches, then quantum dot film will similarly have a circular cross sectional area with a diameter of 0.5 inches. It is also possible for quantum dot film 308 to have a larger cross sectional area than that of housing 306 (e.g., quantum dot film 308 may extend over the sides of housing 306.)

FIG. 3B illustrates a top-down view of local optic 300, according to an embodiment. Housing 306 is seen having a circular cross-section as it surrounds the sides of optical source 304. FIG. 3C illustrates the same top-down view after quantum dot film 308 has been placed over housing 306. Although only one local optic 300 is illustrated, any number of local optic devices may be provided on substrate 302 to provide light across a display screen.

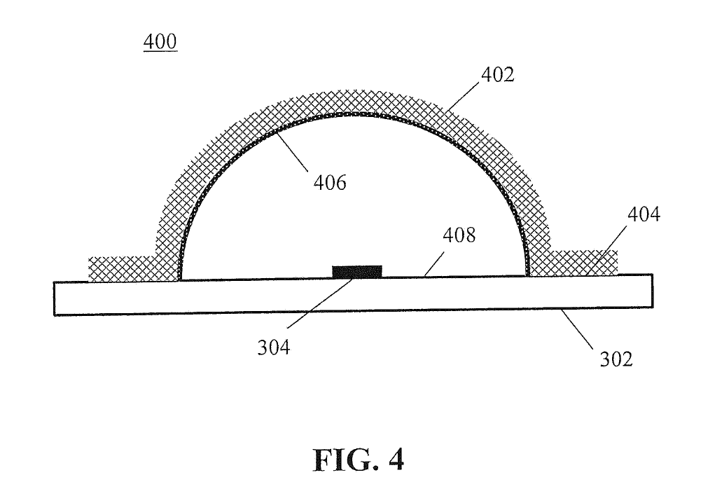

FIG. 4 illustrates another example of a local optic 400. Substrate 302 includes optical source 304 as previously discussed. Surrounding optical source 304 above the surface of substrate 302 is an enclosure 402. Enclosure 402 may be dome shaped (as illustrated) or may take on other shapes so long as optical source 304 remains enclosed. Enclosure 402 is bonded to substrate 302 via interface 404, which may include an adhesive or solder. In one example, enclosure 402 has a diameter between about 0.5 and 1 inch. Enclosure 402 may be cast, molded, or fabricated by using a 3-D printer.

An inner surface of enclosure 402 includes a quantum dot film 406. According to an embodiment, quantum dot film 406 does not require barrier layers to protect the quantum dots from oxygen in the atmosphere, because enclosure 402 is substantially impermeable to oxygen. The area enclosed within enclosure 402 may also be filled with an inert gas. The barrier layers are similar to the first and second layers discussed with reference to FIG. 2. According to an embodiment, enclosure 402 is substantially transparent to the light generated by optical source 304 and from the quantum dots within quantum dot film 406.

Light generated from optical source 304 shines through quantum dot film 406, thus exciting the quantum dots dispersed therein. Shining the light through a dome-like structure may help to provide more uniform light to a display when local optic 400 is arrayed along substrate 302. By exciting quantum dots along a domed surface, the generated light is spread out further. In some embodiments, enclosure 402 includes other optical elements, such as lenses, mirrors, gratings, or diffusors, integrated with enclosure 402.

Local optic 400 may also include a reflective surface 408 on substrate 302 beneath enclosure 402. Reflective surface 408 may be formed using fabrication methods known to a person skilled in the art. Reflective surface 408 may be provided to reflect any stray light that has reflected back off of either quantum dot film 406 or enclosure 402.

Although only one local optic 400 is illustrated, any number of local optic devices may be provided on substrate 302 to provide light across a display screen.

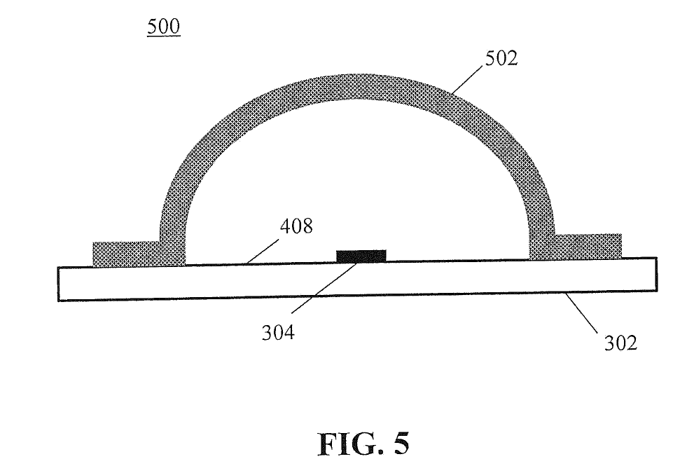

FIG. 5 illustrates another example of a local optic 500. Substrate 302 includes optical source 304 as previously discussed. Surrounding optical source 304 above the surface of substrate 302 is an enclosure 502. Enclosure 402 may be dome shaped (as illustrated) or may take on other shapes so long as optical source 304 remains enclosed.

According to an embodiment, enclosure 502 includes quantum dots dispersed within the material of enclosure 502. Enclosure 502 may be a polymer or glass. The quantum dots may each be encapsulated within a glass bead before being dispersed within the material of enclosure 502. The glass beads protect the quantum dots while they are dispersed within the material of enclosure 502. Local optic 500 may also include reflective surface 408, as previously discussed. In one example, enclosure 502 has a diameter between about 0.5 and 1 inch. According to an embodiment, enclosure 502 is substantially transparent to the light generated by optical source 304 and from the quantum dots disposed within the material of enclosure 502. A thickness of enclosure 502 may be varied. In one example, a uniform thickness of enclosure 502 may be selected such that there are either more or fewer quantum dots being excited by optical source 304. In another example, a thickness of enclosure 502 may vary along the surface of enclosure 502, which can help maintain color uniformity.

Other reflective elements may be included along the inner walls of either enclosure 402 or enclosure 502. These reflective elements may be used to either increase the intensity of light that ultimately impinges upon the quantum dots, or to direct the light out of a particular portion of the enclosure.

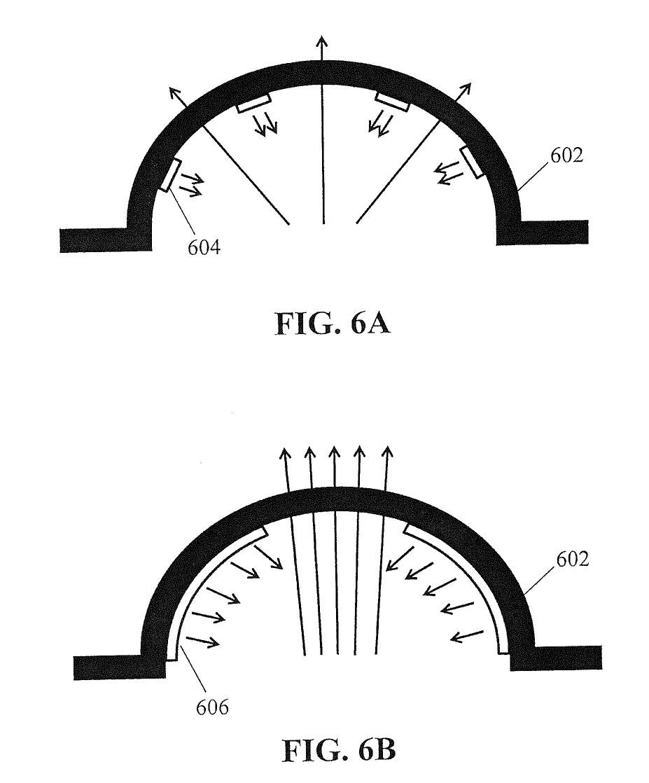

FIG. 6A illustrates an example of an enclosure 602 having a plurality of reflective elements 604. As can be seen by the arrows, light can escape from enclosure 602 in the areas between the plurality of reflective elements 604, but the light is reflected back when it impinges upon the plurality of reflective elements 604. Reflective elements 604 may extend around the inner surface of enclosure 602 in a circular pattern, or they may be placed at discrete locations around the inner surface of enclosure 602. It should be understood that enclosure 602 may represent either enclosure 402 or enclosure 502.

FIG. 6B illustrates another example of enclosure 602 having a larger reflective element 606. As can be seen by the arrows, light can escape from enclosure 602 in a smaller area between reflective element 606, but the light is reflected back when it impinges upon reflective element 606. Reflective element 606 extends around the inner surface of enclosure 602 in a circular pattern, thus leaving only the top portion of enclosure 602 open for light to escape. This design may greatly increase the amount of light that exits through the opening between reflective element 606. This design also imparts more directionality onto the light that exits from enclosure 602.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A local optic, comprising:
an optical source on a substrate;
a housing disposed around the optical source, and having a cross-sectional area along a plane parallel to a surface of the substrate; and
a film comprising quantum dots, wherein the film is disposed on a top surface of the housing, and wherein the film has a substantially similar cross-sectional area to the cross-sectional area of the housing.

2. The local optic of claim 1, wherein the optical source is a LED.

3. The local optic of claim 1, wherein the housing has a circular cross-sectional area.

4. The local optic of claim 1, wherein the housing has a square or rectangular cross-sectional area.

5. The local optic of claim 1, wherein the film includes a first layer, a second layer, and an adhesive material disposed between the first layer and the second layer, the adhesive material comprising the quantum dots.

6. The local optic of claim 5, wherein the first layer and the second layer are polyethylene terephthalate (PET) films.

7. The local optic of claim 1, further comprising:
a plurality of optical sources on the substrate;
a plurality of housing elements, each housing element disposed around a corresponding optical source of the plurality of optical sources; and
a plurality of films, each film of the plurality of films comprising quantum dots, and wherein each film is disposed on a top surface of a corresponding housing element.

8. A local optic, comprising:
an optical source on a substrate;
an enclosure coupled to a surface of the substrate, and surrounding the optical source above the surface of the substrate; and
a film comprising quantum dots, wherein the film is located along an inner surface of the enclosure.

9. The local optic of claim 8, wherein the enclosure has a dome shape.

10. The local optic of claim 9, wherein the enclosure has a diameter between 0.5 and 1 inch.

11. The local optic of claim 8, wherein the enclosure is coupled to the surface of the substrate using solder or an adhesive.

12. The local optic of claim 8, wherein the surface of the substrate under the enclosure includes a reflective material.

13. The local optic of claim 8, wherein the area under the enclosure is filled with an inert gas.

14. The local optic of claim 8, wherein the enclosure is substantially transparent to light generated by the optical source and by the quantum dots.

15. The local optic of claim 8, wherein the enclosure includes one or more reflective elements configured to reflect light back towards the substrate.

16. The local optic of claim 8, further comprising:
a plurality of optical sources on the substrate;
a plurality of enclosures, each enclosure configured to surround a corresponding optical source of the plurality of optical sources; and
a plurality of films, each film of the plurality of films comprising quantum dots, and wherein each film is located along an inner surface of a corresponding enclosure.

17. A local optic, comprising:
an optical source on a substrate; and
an enclosure coupled to a surface of the substrate, and surrounding the optical source above the surface of the substrate,
wherein the enclosure includes quantum dots dispersed within the material of the enclosure, and wherein each quantum dot dispersed within the material of the enclosure is encased within a glass bead.

18. The local optic of claim 17, wherein the surface of the substrate under the enclosure includes a reflective material.

19. The local optic of claim 17, wherein the enclosure has a dome shape with a diameter between 0.5 and 1 inch.

20. The local optic of claim 17, wherein the enclosure includes one or more reflective elements configured to reflect light back towards the substrate.
